(19) United States
(12) Patent Application Publication
(10) Pub. No.: US 2013/0134342 A1
(43) Pub. Date: May 30, 2013

(54) GAS SAFETY VALVE

(71) Applicant: Jesse Shiffer, Denver, CO (US)

(72) Inventor: Jesse Shiffer, Denver, CO (US)

(21) Appl. No.: 13/304,650

(22) Filed: Nov. 26, 2011

(51) Int. Cl. F16K 5/06

(52) U.S. Cl. 251/315.01

(57) ABSTRACT

The present invention is a gas safety valve utilized in combination with an existing carbon monoxide protection system that includes one or more carbon monoxide detectors to detect carbon monoxide in an area protected by the existing carbon monoxide protection system, a signal wire system, a breaker box, a gas meter box, a notification system, a primary gas line and a back-up power source. The gas safety valve is a ball valve that is integral to the primary gas line that is in communication with the carbon monoxide detectors with an electrical signal line that transmits a low voltage electronic signal to the gas safety valve when carbon monoxide is detected.

### TECHNICAL FIELD & BACKGROUND

Many homes and office buildings employ the use of natural gas for cooking and heating purposes. If the occupants of a home or building are unaware of a gas leak, it can cause a fire and possibly lead to serious injuries or death.

The present invention generally relates to a safety valve. More specifically, the invention is a gas safety valve.

It is an object of the invention to provide a gas safety valve utilized in combination with an existing carbon monoxide protection system to prevent carbon monoxide poisoning.

It is an object of the invention to provide a gas safety valve utilized in combination with an existing carbon monoxide protection system that reduces a possibility of the existing carbon monoxide protection system from failing.

It is an object of the invention to provide a gas safety valve utilized in combination with an existing carbon monoxide protection system with a carbon monoxide detector that controls an actuator that can shut-down the carbon monoxide producing source from the existing carbon monoxide protection system.

What is really needed is a gas safety valve utilized in combination with an existing carbon monoxide protection system that reduces the possibility of the existing carbon monoxide protection system failing and that controls an actuator that can shut-down the carbon monoxide producing source from the existing carbon monoxide protection system.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a gas safety valve utilized in combination with an existing carbon monoxide protection system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

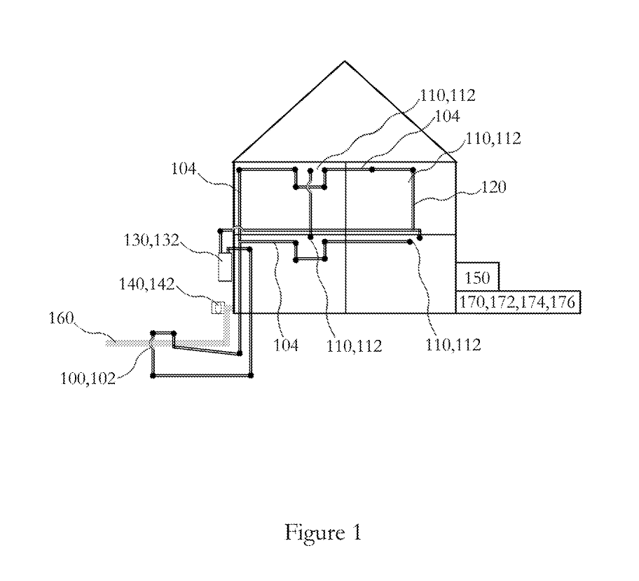

FIG. 1 illustrates a front view of a gas safety valve 100 utilized in combination with an existing carbon monoxide protection system, in accordance with one embodiment of the present invention.

The gas safety valve 100 is utilized in combination with an existing carbon monoxide protection system that includes one or more carbon monoxide detectors 110, a signal wire system 120, a breaker box 130, a gas meter box 140, a notification system 150, a primary gas line 160 and a back-up power source 170.

The carbon monoxide detectors 110 detect carbon monoxide in an area protected by the existing carbon monoxide protection system. The carbon monoxide detectors 110 can be positioned in any desired arrangement and with any desirable number of carbon monoxide detectors. Typically the carbon monoxide detectors 110 are a suitable type of detector head 112 but can be any suitable type of carbon monoxide detector. The signal wire system 120 allows for communication between the carbon monoxide detectors 110 and other subsequently described elements of the existing carbon monoxide protection system. The communication between the carbon monoxide detectors 110 and other subsequently described elements of the existing carbon monoxide protection system is typically communicating electronic signal information however the communication can be any suitable type of communication such as fiber optic communication as well. The breaker box 130 houses a plurality of breakers 132 that prevent the existing carbon monoxide protection system from electrical overloading. The gas meter box 140 houses a gas meter 142 that is typically a natural gas or a liquid petroleum or LP gas meter that meters and measures a volume or other quantity of natural gas or liquid petroleum or LP gas being pumped and distributed into a building, another structure, an environment, an area or a venue. The notification system 150 is typically an alarm system that notifies persons protected by the existing carbon monoxide protection system that carbon monoxide is present. The primary gas line 160 provides natural gas or a liquid petroleum or LP gas to the gas meter box 140 and gas meter 142 that meters and measures a volume or other quantity of natural gas or liquid petroleum or LP gas being pumped and distributed into the building, the other structure, the environment, the area or the venue. The back-up power source 170 is typically a battery back-up source 172, a solar power source 174 such as one or more solar panels 176 or other suitable back-up power source 170.

The gas safety valve 100 is typically a ball valve 102 although the gas safety valve 100 can be any other suitable type of gas safety valve. The gas safety valve 100 is integral to the primary gas line 160 and is in communication with the carbon monoxide detectors 110 with an electrical signal line 104 or other suitable communication that transmits a relatively low voltage electronic signal to the gas safety valve 100 when carbon monoxide is detected by the carbon monoxide detectors 110. The relatively low voltage electronic signal activates the gas safety valve 100 to shut-off the incoming natural gas or liquid petroleum or LP gas being pumped and distributed into the building, other structure, the environment, the area or the venue by the primary gas line 160. By shutting-off the incoming natural gas or liquid petroleum or LP gas, a possibility of carbon monoxide poisoning of persons or ignition of the incoming natural gas or liquid petroleum or LP gas is relatively reduced significantly providing relatively greater safety than the existing carbon monoxide protection system without the gas safety valve 100.

The gas safety valve relatively quickly and efficiently turns off the incoming gas line when notified of a gas leak. The gas safety valve works as a supplement to carbon monoxide and smoke detectors by sending a low voltage signal to electronically shut-off an incoming gas line by utilizing an electrical line. The gas safety valve can be simply placed on a wall inside or outside a home or other venue near a gas meter and is in communication with an existing notification system. The gas safety valve may be fully operational in the event of an electrical outage because it can be powered by a back-up battery or a solar power source. The gas safety valve can also be tied into a radio frequency for communication with other technologies exterior to the protected area protected by the existing carbon monoxide protection system and can be utilized by emergency first responders, utility crews and other suitable persons.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A gas safety valve utilized in combination with an existing carbon monoxide protection system that includes one or more carbon monoxide detectors to detect carbon monoxide in an area protected by said existing carbon monoxide protection system, a signal wire system, a breaker box, a gas meter box, a notification system, a primary gas line and a back-up power source, comprising:
a ball valve integral to said primary gas line that is in communication with said carbon monoxide detectors.

2. The gas safety valve according to claim 1, wherein said breaker box houses a plurality of breakers that prevent said existing carbon monoxide protection system from electrical overloading.

3. The gas safety valve according to claim 1, wherein said gas meter box houses a gas meter.

4. The gas safety valve according to claim 3, wherein said gas meter is a natural gas meter.

5. The gas safety valve according to claim 3, wherein said gas meter that is a liquid petroleum gas meter.

6. The gas safety valve according to claim 1, wherein said notification system is an alarm system that notifies one or more persons protected by said existing carbon monoxide protection system that carbon monoxide is present.

7. The gas safety valve according to claim 1, wherein said primary gas line provides said gas that is pumped and distributed into said protected area.

8. The gas safety valve according to claim 1, wherein said back-up power source is a battery back-up.

9. The gas safety valve according to claim 1, wherein said ball valve is in communication said carbon monoxide detectors with an electrical signal line.

10. The gas safety valve according to claim 1, wherein said electrical signal line transmits a low voltage electronic signal to said ball valve when carbon monoxide is detected.

11. A gas safety valve utilized in combination with an existing carbon monoxide protection system that includes one or more carbon monoxide detectors to detect carbon monoxide in an area protected by said existing carbon monoxide protection system, a signal wire system, a breaker box, a gas meter box, a notification system, a primary gas line and a back-up power source, comprising:
a ball valve integral to said primary gas line that is in communication with said carbon monoxide detectors with an electrical signal line.

12. The gas safety valve according to claim 11, wherein said breaker box houses a plurality of breakers that prevent said existing carbon monoxide protection system from electrical overloading.

13. The gas safety valve according to claim 11, wherein said gas meter box houses a gas meter.

14. The gas safety valve according to claim 13, wherein said gas meter is a natural gas meter or a liquid petroleum gas meter.

15. The gas safety valve according to claim 11, wherein said notification system is an alarm system that notifies one or more persons protected by said existing carbon monoxide protection system that carbon monoxide is present.

16. The gas safety valve according to claim 11, wherein said primary gas line provides said gas that is pumped and distributed into said protected area.

17. The gas safety valve according to claim 11, wherein said back-up power source is a battery back-up or a solar power source.

18. The gas safety valve according to claim 11, wherein said electrical signal line transmits a low voltage electronic signal to said gas safety valve when carbon monoxide is detected.

19. The gas safety valve according to claim 18, wherein said electronic low voltage electronic signal activates said gas safety valve to shut-off incoming natural gas or liquid petroleum gas being pumped and distributed into said protected area by said primary gas line.

20. The gas safety valve according to claim 19, wherein said shutting-off said incoming natural gas or liquid petroleum gas, reduces a possibility of carbon monoxide poisoning of one or more persons or ignition of said incoming natural gas or liquid petroleum gas providing greater safety in said protected area.
